(19) United States
(12) Patent Application Publication
(10) Pub. No.: US 2024/0320544 A1
(43) Pub. Date: Sep. 26, 2024

(54) OBJECT AFFINITY DETERMINATION AND SCORING SYSTEM

(71) Applicant: Adobe Inc., San Jose, CA (US)

(72) Inventors: Ajay Jain, Ghaziabad (IN); Michele Saad, Austin, TX (US)

(73) Assignee: Adobe Inc., San Jose, CA (US)

(21) Appl. No.: 18/187,864

(22) Filed: Mar. 22, 2023

(51) Int. Cl. G06N 20/00; G06F 9/451

(52) U.S. Cl. CPC G06N 20/00; G06F 9/451

(57) ABSTRACT

An object affinity determination and scoring system is described that is configured to support control by object providers in locating related objects. In a first example, an affinity system supports generation of affinity rules through interaction with a rule generation user interface. In a second example, the affinity system supports training and retraining of a machine-learning model to generate the affinity score. In a third example, the affinity scoring module supports output of a user interface having an input portion that supports user interaction to determine an affinity of selected objects to each other.

### BACKGROUND

Digital services are continually developed to support increases in user access via a network to hundreds of thousands and even millions of objects. The objects, for instance, include digital content provided by the digital services, itself, examples of which include digital images, digital videos, digital books, digital documents, streaming music services, and so forth. The objects are also configurable to represent, via the digital services, other physical objects in the real world.

Techniques usable to locate objects of interest, however, are challenged by the numbers of objects that are available via the digital services. Conventional search techniques therefore introduce user inefficiencies in locating the objects as well as inefficiencies of computing devices that implement the digital services, which results in computational inefficiencies and increased power consumption.

### SUMMARY

An object affinity determination and scoring system is described that is configured to support control by object providers in locating related objects. In a first example, an affinity system supports generation of affinity rules through interaction with a rule generation user interface, e.g., to specify affinity of different attributes of different objects to each other. In a second example, the affinity system supports training and retraining of a machine-learning model to generate the affinity score. In a third example, the affinity scoring module supports output of a user interface having an input portion (e.g., a canvas) that supports user interaction to determine an affinity of selected objects to each other.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an object affinity determination and scoring environment in an example implementation that is operable to employ techniques described herein.

FIG. 2 depicts a system in an example implementation showing operation of an affinity system of FIG. 1 in greater detail.

FIG. 3 depicts an example implementation of a schema generated based on the attributes.

FIG. 4 depicts an example implementation showing display of a rule generation user interface configured to support manual interaction to generate an affinity rule specifying a positive amount of affinity between objects for use as part of object affinity determination and scoring.

FIG. 5 depicts an example implementation showing display of a rule generation user interface configured to support manual interaction to generate an affinity rule specifying a negative amount of affinity between objects for use as part of object affinity determination and scoring.

FIG. 6 depicts a flow diagram in an example procedure in which inputs are received via a rule generation user interface to generate an affinity rule.

FIG. 7 depicts an example system in which affinity data is generated to train a machine-learning model to generate affinity scores.

FIG. 8 depicts a system in an example implementation in which the affinity data generated in FIG. 7 is used to train a machine-learning model to generate affinity scores.

FIG. 9 is a flow diagram depicting a procedure in an example implementation of generating training data and training a machine-learning model to generate affinity scores.

FIG. 10 depicts a system in an example implementation in which an input portion of a user interface operates as a canvas to support user inputs to determine affinity of objects to each other.

FIG. 11 is a flow diagram depicting a procedure in an example implementation in which an input portion of a user interface operates as a canvas to support user inputs to determine affinity of objects to each other.

FIG. 12 illustrates an example system including various components of an example device that can be implemented as any type of computing device as described and/or utilize with reference to FIGS. 1-11 to implement embodiments of the techniques described herein.

### DETAILED DESCRIPTION

### Overview

Digital services support user access to a multitude of objects, from digital objects provided by the digital services themselves as well as representations of physical objects in the real world. As such, in the following discussion the term “object” refers to a digital object, a digital object that represents a physical object, as well as a physical object.

Because of the multitude of objects that are made available via the digital services, conventional search techniques employed by the digital services are challenged with providing accurate search results. For example, text-based approaches rely on an ability of a provider of the object to accurately express text that describes the object as well as an ability of a searcher to also accurately use text to express a desired outcome, which result in inaccuracies and computational inefficiencies. Further, conventional approaches to locate related objects do not support a degree of control by providers of the objects, but rather operate behind-the-scenes and are invisible to the object providers.

Accordingly, an object affinity determination and scoring system is described that is configured to support control by object providers in locating related objects, which is not possible in conventional techniques. Affinity refers to a degree of compatibility objects have in relation to each other. Affinity is definable based on visual compatibility of the objects (e.g., complimentary colors), physical compatibility (e.g., physical utility realized between two objects such as a hammer and nail), operational compatibility (e.g., an ability to operate together), a natural attraction or preference one object has for another object (e.g., a plant and a type of plant food), and so forth.

In a first example, an affinity system supports generation of affinity rules through interaction with a rule generation user interface, e.g., to specify affinity of different attributes of different objects towards each other. The rules are then usable by an affinity scoring module to generate an affinity score for subsequent objects based on the objects as well as attributes for those objects.

Consider a scenario in which the rule generation user interface includes representation of objects as well as representations of attributes of those objects. User inputs received via the user interface are therefore usable as a basis to generate an affinity rule based on that interaction. The inputs for instance, select a first object representing “pants” and a second object representing a “shirt.” The inputs then specify an attribute for the pants (e.g., blue) and an attribute for the shirt, e.g., white. A control is also output in the user interface to specify an affinity of those attributes for those objects, e.g., through use of a slider control to specify a value of “seven” in a range of zero to ten. As a result, the affinity rule generated based on these inputs is usable to generate an affinity score for subsequent combinations of objects and attributes to promote surfacing of those other objects as part of a search.

Affinity rules are also usable to specify that objects do not have an affinity towards each other, i.e., a negative affinity. Similar to the above example, inputs are received via the rule generation user interface that select a first object representing “pants” and a second object representing a “shirt.” The inputs then specify attributes for the pants (e.g., orange) and an attribute for the shirt, e.g., red. The control is then used to specify a negative affinity of those attributes in relation to each other, e.g., as “one” in the range of zero to ten above indicating that these items are not to be grouped together in a search result. Therefore, an affinity rule generated by these inputs is usable to restrict formation of subsequent combinations of those objects and attributes, thereby also giving the object provider an increased degree of control as to what other objects are surfaced in a search result along with the object.

In a second example, the affinity system supports training and retraining of a machine-learning model to generate the affinity score. In order to generate the training data, digital images are obtained from a digital service, e.g., social media service, photo-sharing service, digital retailer, and so forth. Machine-learning models are then utilized to identify objects included in the digital image and attributes of those objects. In an implementation, inclusion of those objects on a same entity is also determined, e.g., clothing worn by a particular entity, attributes associated with parts of a vehicle (e.g., wheel and color combinations for respective automobiles), and so forth.

The attributes and objects are then correlated together as “positive” examples of attribute/object combinations as part of training data. Similar to the above example, for instance, colors and types of objects worn by a same entity in a digital image are indicated as having a positive affinity to each other. Negative samples may also be generated in an example, e.g., through randomized editing of the positive samples, through introduction of perturbations, and so forth. The training data is then used, as part of machine learning, to train a machine-learning model to generate an affinity score indicative of a relative amount of affinity of objects and corresponding attributes have to each other.

An affinity scoring module (e.g., that leverages the affinity rules and/or the trained machine-learning model) is then usable in support of a variety of functionality. The affinity scoring module, for instance, is usable as part of a search technique to generate an affinity score to surface additional objects based on an input object, e.g., as product recommendations.

In a third example, the affinity scoring module supports output of a user interface having an input portion (e.g., a canvas) that supports user interaction to determine an affinity of selected objects to each other. Consider a scenario in which a plugin module is executed as part of a browser by a client device. The plugin module supports display of an input portion (i.e., the “canvas”) that is configured to persist through navigation between a plurality of different webpages. User inputs are also supported to specify which objects are to be included within the input portion, e.g., as a drag-and-drop of objects from the webpage into the input portion.

The plugin module, based on the user inputs, communicates with an affinity system (e.g., executed locally and/or “in the cloud” by a service provider system) to generate an affinity score based on the objects. The affinity score is then displayed in the user interface (e.g., within the input portion) to specify a relative amount of affinity of the objects and attributes of the object have to each other, e.g., as a numerical score, graphical indication, and so forth. As a result, the user is given additional insight into the objects that is not possible in conventional techniques. Additional examples are also contemplated, e.g., in which the affinity scoring module is incorporated as part of a single service provider system. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

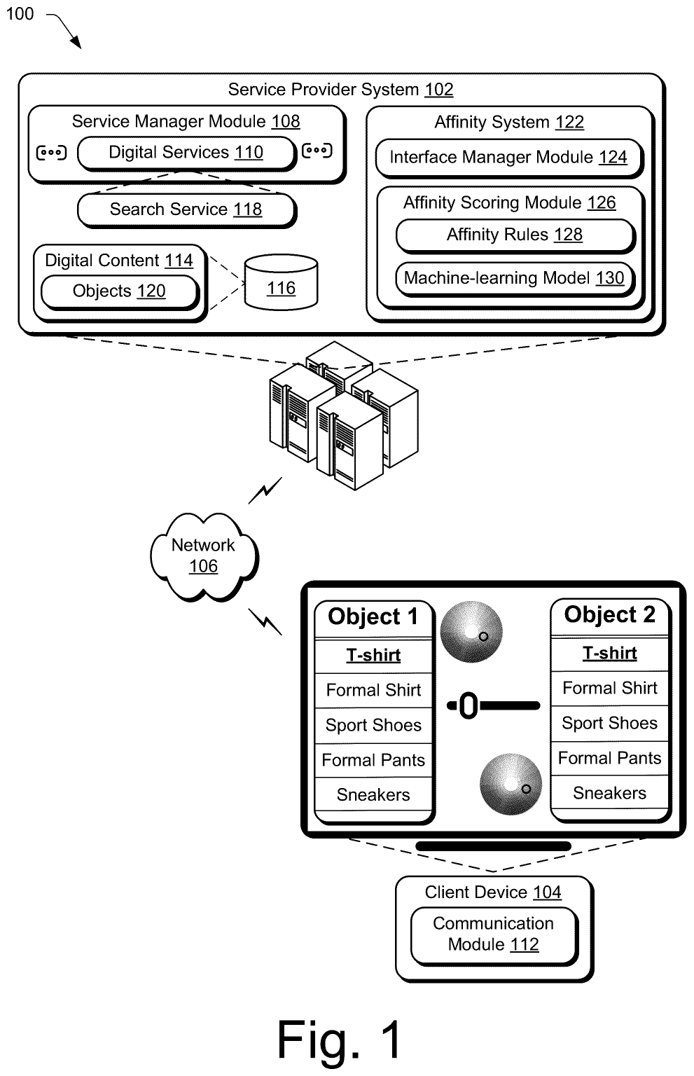

FIG. 1 is an illustration of an object affinity determination and scoring environment 100 in an example implementation that is operable to employ techniques described herein. The illustrated environment 100 includes a service provider system 102 and a client device 104 that are communicatively coupled, one to another, via a network 106. Computing devices that implement the service provider system 102 and the client device 104 are configurable in a variety of ways.

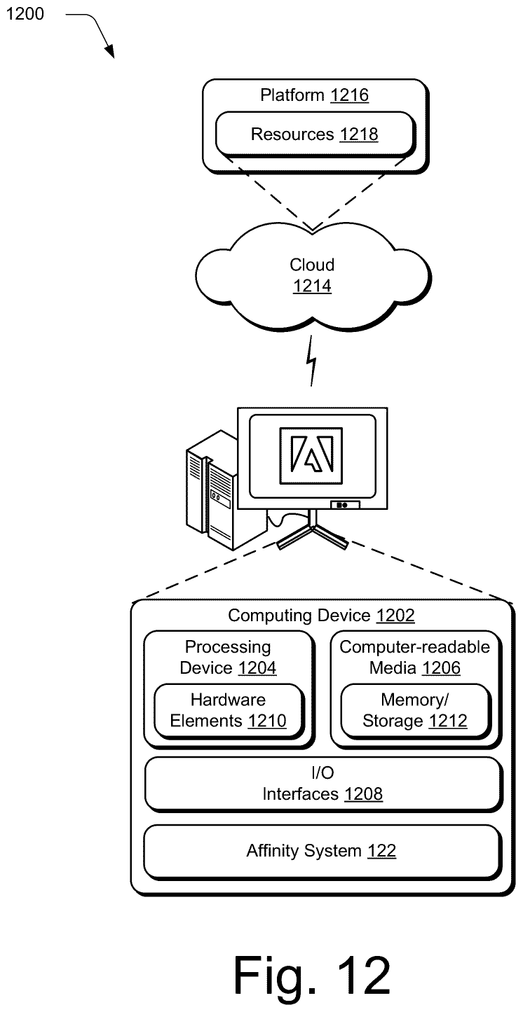

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and discussed in some examples, a computing device is also representative of a plurality of different devices, such as multiple servers utilized by a business to perform operations “over the cloud” as described in FIG. 12.

The service provider system 102 includes a service manager module 108 that represents functionality usable to implement and manage operation of digital services 110. Digital services 110 are accessible remotely over the network 106 by the client device 104 using a communication module 112, e.g., a network-enabled application, plug-in module, browser, and so forth. The service provider system 102, as implementing a network platform, implements the digital services 110 through execution of software by respective servers or other hardware devices.

Digital services 110 are configurable to support a wide variety of functionality, including management and distribution of digital content 114 which is illustrated as stored in a storage device 116. In a first example, digital services 110 support social networking that is used to share digital content 114 as digital images, videos, and status updates through corresponding profiles. In a second example, the digital services 110 support the digital content 114 as part of messaging and communication between corresponding client devices 104. In a third example, the digital services 110 support streaming of the digital content 114 to the client device 104, e.g., streaming of digital audio, digital movies, and so forth.

Another example of a digital service 110 (and functionality included as part of implementing the digital services) includes a search service 118. In a scenario in which the search service 118 is the digital service 110, the search service 118 is usable to locate particular items of digital content 114 based on a search query. A search interface of the communication module 112, for instance, is usable to initiate a search query, which is proceeded by the search service 118 to generate a search result which is returned to the client device 104. In a scenario in which the search service 118 supports functionality of the digital service 110, the search service 118 is used to locate items of digital content 114 in support of the digital services 110. A recommendation engine, for instance, is implemented by the search service 118 to generate a search result as content-based recommendations, e.g., based on a user's past behavior and exhibited preferences, use of collaborative filtering, implemented for hybrid recommendations, and so forth.

As previously described, digital services 110 support user access to a multitude of objects 120. In a first example, the objects 120 refer the items of digital content 114, itself, as illustrated, e.g., digital music, digital images, digital media, and so forth. In a second example, the objects 120 included in the digital content 114 refer to representations of physical objects in the real world, e.g., a thumbnail digital image that depicts an item of clothing. Accordingly, in this second example a visual appearance of the objects 120 in the digital content 114 mimics a visual appearance of the physical object in the real world. In the following discussion, therefore, the term “object” refers to an item of digital content 114 itself, a digital object that represents a physical object, as well as a physical object.

Conventional search approaches to locate related objects do not support a degree of control by entities associated with the objects, but rather operate behind-the-scenes and are invisible to the entities. In a digital image search example, for instance, an entity may provide a workbook of thousands of object depictions, e.g., for upload as part of a stock image digital service. Conventional techniques used to search these objects, however, do not provide a degree of control by the entity in defining relationships between the objects 120, such as to specify an affinity one object may have with respect to another object. Consequently, the entity is not able to define which objects correspond with other objects when searched using a conventional search service.

To address these technical challenges, an affinity system 122 is described that includes functionality to address an affinity of objects in relation to each other, e.g., in support of a search performed by a search service 118. Examples of affinity functionality are represented as an interface manager module 124 and an affinity scoring module 126. The affinity scoring module 126 is illustrated as including affinity rules 128 and a machine-learning model 130.

The interface manager module 124 is representative of functionality to implement a rule generation user interface, via which, inputs are received that are usable to generate the affinity rules 128. The affinity rules 128 are then usable by the affinity scoring module 126 to generate affinity scores that quantify respective amounts of affinity an object has toward another object. The affinity scores are usable as part of the search service 118 to quantify affinity of objects towards each other as part of generating a search result. Use of affinity scores as part of a search service 118 is usable to provide a degree of control to object providers that is not possible in conventional techniques.

Consider a scenario in which an object provider manufactures and sells various types of shirts. Categories of shirts sold by the object provider include casual shirts with half sleeves, full sleeves, hoodies, sportswear, and athletic shirts. The object provider also supplies various shirt types for use in various seasons, e.g., casual cotton half sleeve shirts during the summer, while thick hoodies are supplied during the winter. The object provider also sells across the country so while there is a moderate winter in one part of the country, there is a strong snow/icy temperature in other parts of the country. As such, the object provider is also tasked with continued monitoring of the demand for the shirts at different geographic locations.

Although the object provider provides a good range of shirts, the object provider may notice that other clothing items typically worn with shirts are not in demand, e.g., jeans (different colors), shoes, and so forth. Conventional search techniques, however, do not support control by the object provider of search results (e.g., recommendations) of related objects. However, in the techniques described herein the affinity system 122 is configured to support affinity control, such as to enable an object provider to control a bundled product recommendation with objects from other object providers.

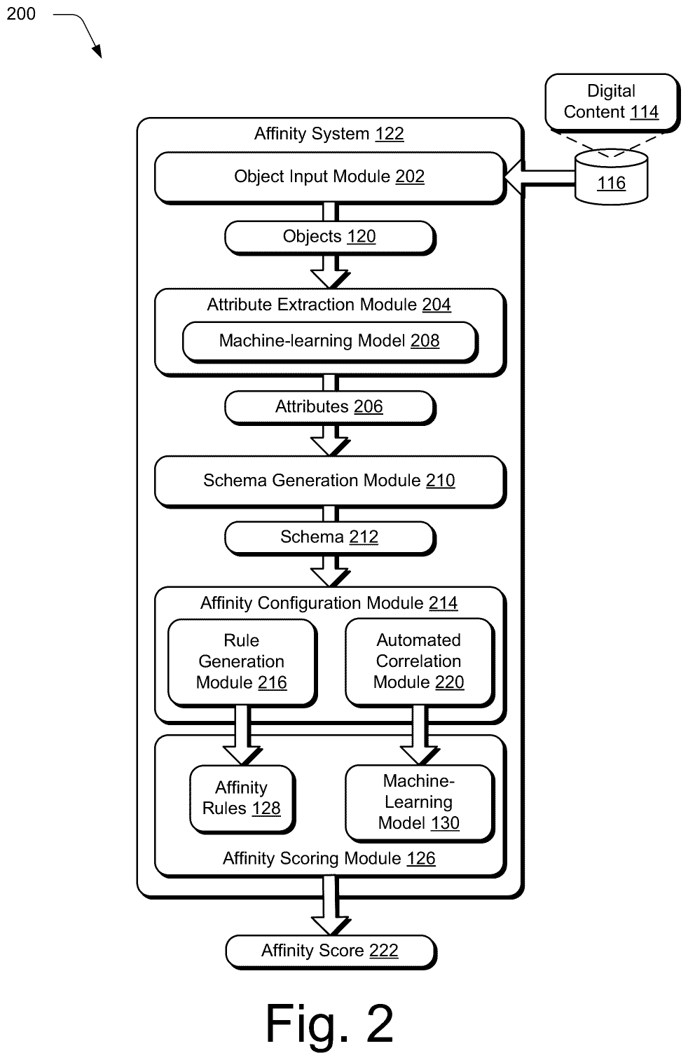

FIG. 2 depicts a system 200 in an example implementation showing operation of the affinity system 122 of FIG. 1 in greater detail. To begin, an object input module 202 is employed to input objects 120. The objects 120, for instance, are included as part of digital content 114 stored in a storage device 116. As previously described, objects 120 are configurable in a variety of ways, such as items of digital content itself (e.g., digital images, digital music, digital documents, digital media, digital books), representative of physical objects (e.g., a thumbnail, icon, or other representation of a physical item), or reference an actual physical object.

An attribute extraction module 204 is then employed to extract attributes 206 from the objects 120. The attributes 206, for instance, are located in metadata associated with the objects 120, respectively. The metadata is configurable to describe product types, categories, and other attributes as follows:

Struct product {
Product_type (jeans, t-shirt, trousers, shoes...)
Category (apparel, décor,...)
Price_range (min x, max y)
Key_attributes (Partywear, casuals, sports,...)_{—}
Event_attributes (Christmas, festival, newyear...)
Geography_attributes (summer, winter...)
Color (1...n)
Size (x...y)
}

In another example, the attributes 206 are generated automatically and without user intervention by a machine-learning model 208 by processing the objects 120. The objects 120, for instance, include digital images that are processed by the machine-learning model 208 as a classifier to identify attributes 206 associated with the objects 120. Attributes 206 identifiable by the classifier therefore include object type, category, geography, seasonal considerations, and any other object attribute capable of being generated by the machine-learning model 208 as implementing a classifier.

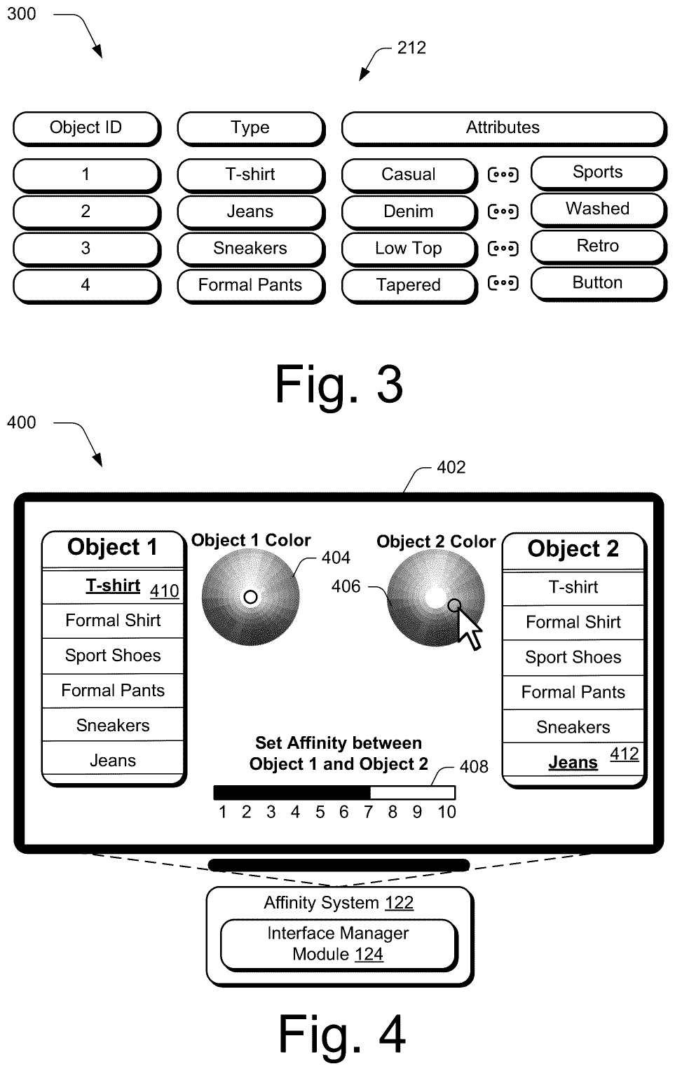

A schema generation module 210 is then employed by the affinity system 122 to generate a schema 212 based on the attributes 206. FIG. 3 depicts an example implementation 300 of a schema 212 generated based on the attributes 206. The schema 212 includes object identifiers (ID) that are used to uniquely identify the objects 120. The schema 212 also identifies an object type, which is used to identify types of clothing in the illustrated example, instances of which include “T-shirt,” “Jeans,” “Sneakers,” and “Formal Pants.” Attributes are also identified for each of the objects.

Returning again to FIG. 2, the schema 212 is received as an input by an affinity configuration module 214. The affinity configuration module 214 is utilized to define an amount of affinity between respective objects. As previously described, affinity refers to a degree of compatibility objects have in relation to each other. Affinity is definable based on visual compatibility of the objects (e.g., complimentary colors), physical compatibility (e.g., physical utility realized between two objects such as a hammer and nail), operational compatibility (e.g., an ability to operate together), a natural attraction or preference one object has for another object (e.g., a plant and a type of plant food), and so forth.

Accordingly, in this example the affinity configuration module 214 is configured to define “how” affinity is defined between respective objects, and thus provide a degree of control in implementing search functionality by the search service 118. The affinity configuration module 214 is configurable to define affinity in a variety of ways. Illustrated examples of affinity definition functionality are represented by a rule generation module 216 that is configurable to generate affinity rules 128 and an automated correlation module 220 that is configured to utilize a machine-learning model 130 to define an amount of affinity between objects.

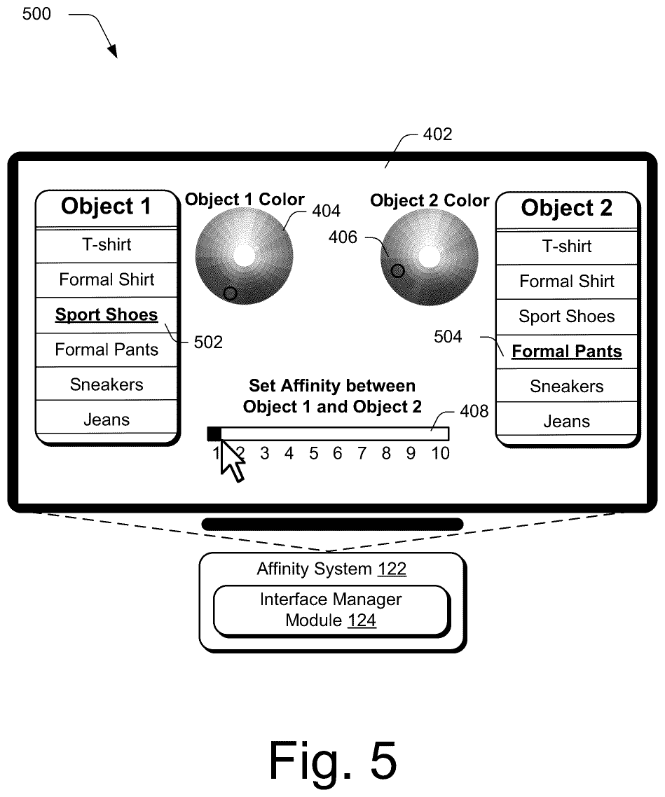

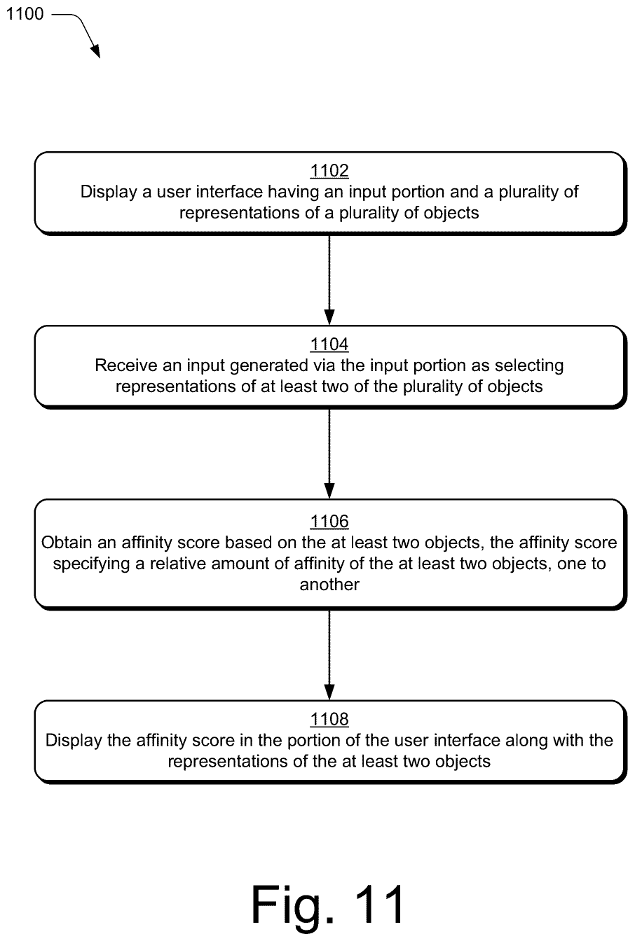

The affinity rules 128 and/or the machine-learning model 130, once configured by the affinity configuration module 214, are then usable by an affinity scoring module 126 to generate an affinity score 222 that quantifies an amount of affinity two or more objects have towards each other. Generation and use of affinity rules 128 as part of a manual configuration is further described in relation to FIG. 4-6. Training and use of a machine-learning model 130 in an automated configuration is further described in relation to FIGS. 7-9. Configuration of a user interface as a canvas in support of affinity determinations is further described in relation to FIGS. 10 and 11.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Affinity Rule Generation User Interface

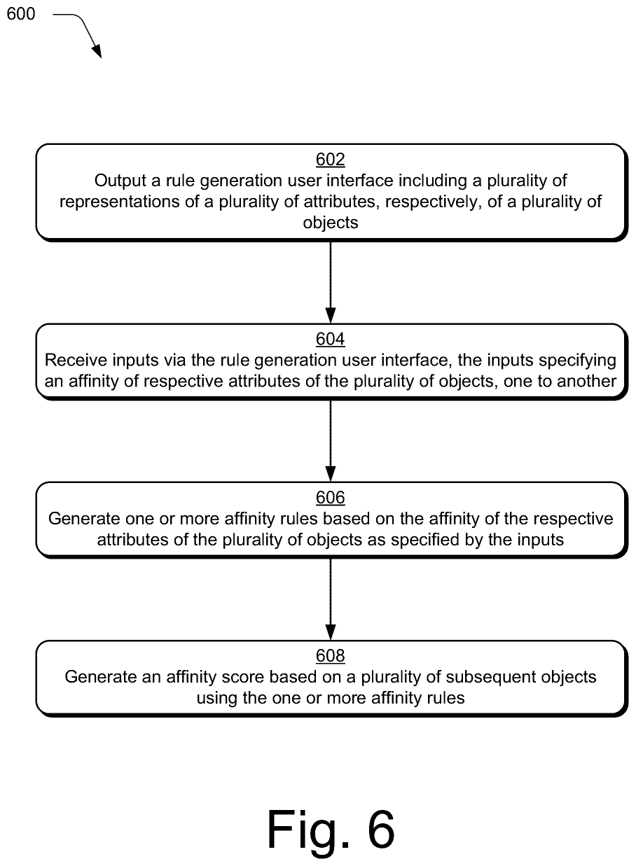

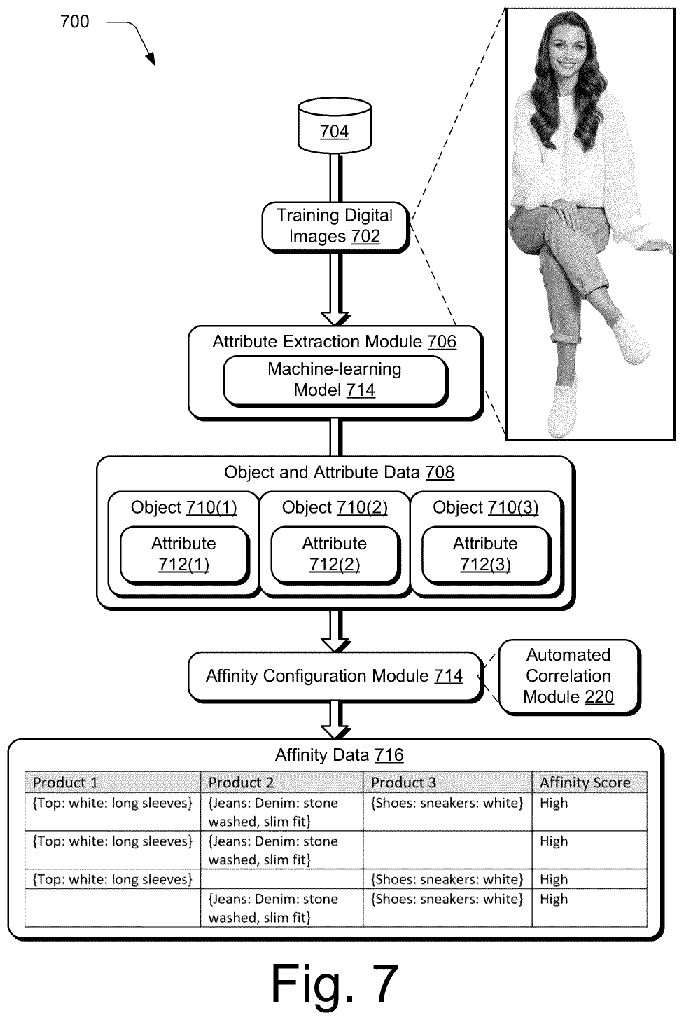

The following discussion describes affinity rule generation techniques that are implementable utilizing the previously described systems and devices. Aspects of the procedure are implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 4 and 5 in parallel with an example procedure 600 of FIG. 6 of generating affinity rules.

FIG. 4 depicts an example implementation 400 showing display of a rule generation user interface configured to support manual interaction to generate an affinity rule specifying a positive amount of affinity between objects for use as part of object affinity determination and scoring. In this example, a rule generation user interface 402 is output. The rule generation user interface 402 includes a plurality of representations of a plurality of attributes, respectively, of a plurality of objects (block 602).

The rule generation user interface 402, for instance, includes representations of different types of objects that are usable to specify the type of object that is to be subject of an affinity rule. In the illustrated example, the rule generation user interface 402 includes representations of types of clothing, including a “t-shirt,” “formal shirt,” “sport shoes,” “formal pants,” “sneakers,” and “jeans.” The rule generation user interface 402 also includes color wheels 404, 406 that are usable to set attributes involving “color” for the respective objects. A control 408 is also output (e.g., as a slider control) that is usable to specify an amount of affinity between the two objects having the corresponding attributes.

Inputs are received via the rule generation user interface 402. The inputs specify an affinity of respective attributes of the plurality of template objects, one to another (block 604). In the illustrated example of FIG. 4, the rule generation user interface 402 includes a representation 410 of “Object 1” as a “t-shirt” and a representation 412 of “Object-2” as “jeans,” which are indicated through selection of corresponding representations. Attributes of “color” are also indicated through use of respective color wheels 404, 406, which is “white” for the “t-shirt” of object 1 and “blue” for the “jeans” of object 2. Inputs are also received via user interaction with the control 408 indicating an amount of affinity objects having those attributes are to have toward each other, e.g., “seven” on a scale of one to ten.

One or more affinity rules are generated based on the affinity of the respective attributes of the plurality of template objects as specified by the inputs (block 606). The interface manager module 124, for instance, receives the above inputs, and from the inputs, generates a corresponding affinity rule. The affinity rule, for instance, if formable directly based on the inputs as following the example above, e.g., “white t-shirts have an affinity of seven with respect to blue jeans.” Generative artificial intelligence techniques are also usable that employ machine-learning models as part of natural language processing to generate the affinity rules automatically and without user intervention, e.g., based on a natural language input.

The affinity rules 128 are then usable by an affinity scoring module 126 to generate an affinity score based on a plurality of subsequent objects using the one or more affinity rules (block 608). The affinity scoring module 126, for instance, is usable as part of a search service 118 to provide the affinity score as part of ranking individual objects in a search result, such as to form a recommendation of a “related object” of digital content 114. In this example, the rule generation user interface 402 is used to specify an amount of affinity indicative that the objects are compatible with each other, e.g., to promote inclusion together as part of a search result. In another example, the rule generation user interface 402 is used to specify an amount of affinity indicative that the objects are not compatible (i.e., have a negative affinity towards each other), an example of which is described as follows.

FIG. 5 depicts an example implementation 500 showing display of a rule generation user interface configured to support manual interaction to generate an affinity rule specifying a negative amount of affinity between objects for use as part of object affinity determination and scoring. As with the previous example, a rule generation user interface 402 is output. The rule generation user interface 402 includes a plurality of representations of a plurality of attributes, respectively, of a plurality of objects.

In the illustrated example, the rule generation user interface 402 includes a representation 502 of “Object 1” as “sport shoes” and a representation 504 of “Object-2” as “formal pants,” which are indicated through selection of corresponding representations. Attributes of “color” are also indicated through use of respective color wheels 404, 406, which is “violet” for the “sport shoes” of object 1 and “red” for the “formal pants” of object 2. Inputs are also received via user interaction with the control 408 indicating an amount of affinity object having those attributes are to have toward each other, e.g., “one” on a scale of one to ten.

As above, the interface manager module 124 receives the inputs and generates a corresponding affinity rule. The affinity rule, in this instance however, indicates an incompatibility between the objects as having those attributes, e.g., “violet sport shoes have an affinity of one with respect to red formal pants.” Accordingly, in this example the affinity rule is usable to restrict output of these objects together or as being compatible. In this example, manual configuration of the affinity rules is performed by the interface manager module 124. Automated techniques based on machine learning are also contemplated, further discussion of which is included in the following section.

### Affinity Training of a Machine-Learning Model

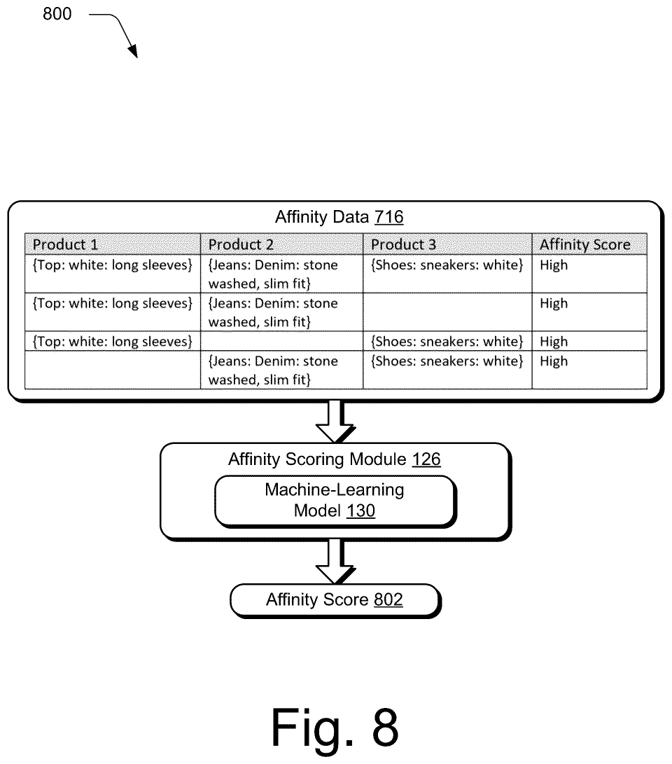

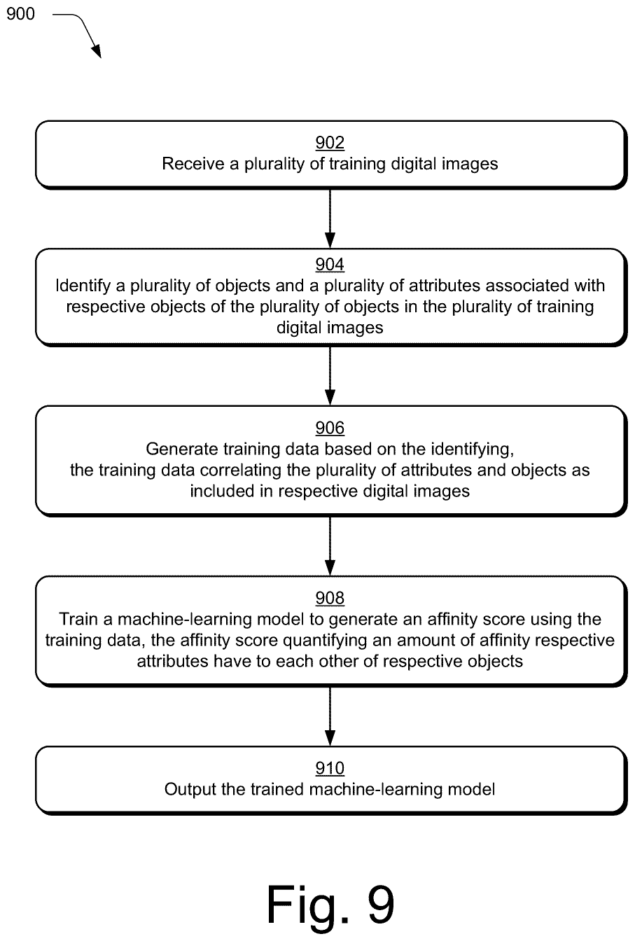

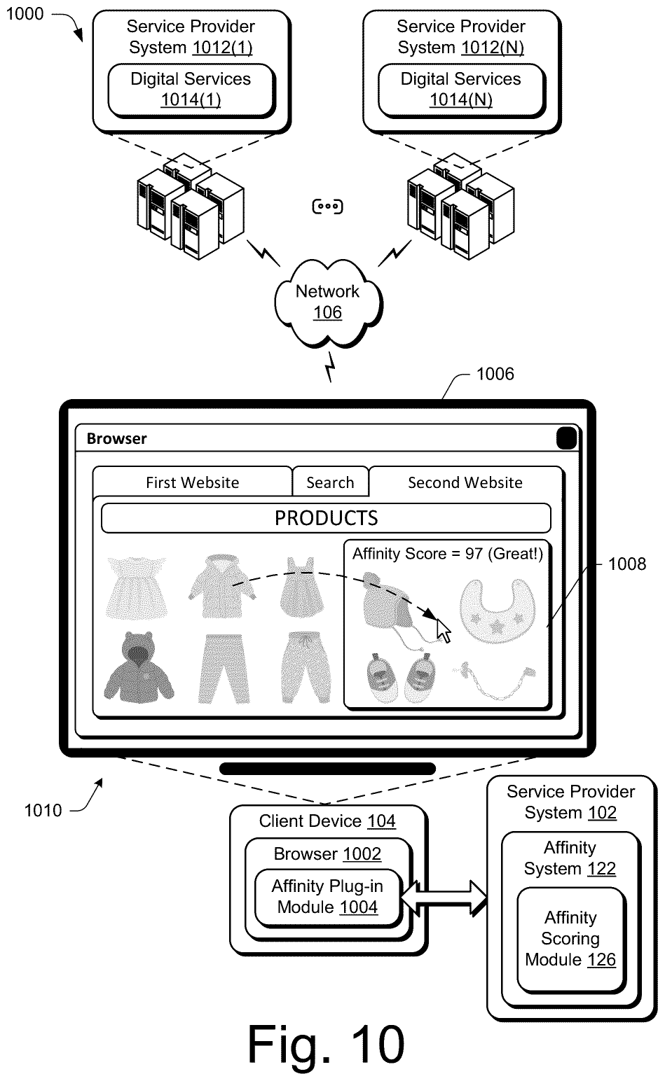

The following discussion describes training and use of machine-learning models that are implementable utilizing the previously described systems and devices. Aspects of the procedure are implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 7 and 8 in parallel with an example procedure 900 of FIG. 9 of training a machine-learning model to generate affinity scores.

FIG. 7 depicts a system 700 in an example in which affinity data 716 is generated to train a machine-learning model to generate affinity scores. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

In this example, the training data is generated to quantify an affinity of objects, one to another, automatically and without user intervention. To do so, a plurality of training digital images 702 is received (block 902) from a training digital image source 704. The training digital image source 704, for instance, is implemented as a repository of publicly available images, e.g., a stock image database, photo sharing service, social network service, and so on.

A plurality of objects and a plurality of attributes associated with respective objects of the plurality of objects are identified in the plurality of training digital images 702 (block 904). To do so, an attribution extraction module 706 is utilized to generate object and attribute data 708 describing combinations of objects (e.g., object 710(1), object 710(2), object 710(3)) with corresponding attributes, e.g., object attribute 712(1), object attribute 712(2), object attribute 712(3). In a first example, the object and attribute data 708, for instance, is extracted from metadata associated with the digital images 702, e.g., image tags.

In a second example, a machine-learning model 714 is used to generate the object and attribute data 708. The machine-learning model 714, for example, is configurable as a classifier that is trained to output a probability that the training digital images 702 include or do not include a respective attribute. The attributes, for instance, are usable to indicate types of objects, visual characteristics of the objects, emotions invoked by the objects, and other semantic attributes.

An affinity configuration module 714 is then utilized to generate affinity data 716 for use as training data to train a machine-learning model to implement an automated correlation module 220 of FIG. 2. The training data, as affinity data 716, correlates the plurality of attributes and objects as included in respective digital images (block 906). Consider the illustrated example of a training digital image 702 captures an image of a model. The model is wearing a white long-sleeved top with blue denim jeans and sneakers. The attribution extraction module 706 analyzes and extracts objects (e.g., clothing items) from the training digital images 702, e.g., the long-sleeved top, denim jeans, and sneakers. The attribution extraction module 706 also extracts attributes of the objects as the object and attribute data 708.

The affinity configuration module 714 is then usable to correlate objects and attributes based on an assumption that the training digital images 702 accurately reflect affinity of the objects towards each other (i.e., are positive samples), as is typically encountered in product descriptions, social media posts, and so on. Continuing with the previous example, the affinity data 716 indicates that a “{top: white: long sleeves}” of a first object, “{Jeans: Denim: stone washed, slim fit}” of a second object, and “{shoes: sneakers: white}” of a third object have a “high” affinity score. Likewise, the affinity data 716 indicates that a “{top: white: long sleeves}” of a first object and “{Jeans: Denim: stone washed, slim fit}” of a second object have a “high” affinity score. Additionally, a “{top: white: long sleeves}” of a first object and “{shoes: sneakers: white}” of a third object also have a “high” affinity score. And further, “{Jeans: Denim: stone washed, slim fit}” of a second object and “{shoes: sneakers: white}” of a third object have a “high” affinity score.

In this example, inclusion of objects as associated with a respective entity are used as a basis to determine affinity of the objects and attributes of those objects in relation to each other as positive samples of training data. Training digital images 702 are also usable for scenarios involving multiple entities. The attribution extraction module 706, for instance, is configurable to also identify correlations of the objects with a respective entity to determine “good” combinations of objects and attributes. Negative samples may also be generated, e.g., through randomized editing of the positive samples, through introduction of perturbations, and so forth.

In this way, affinity between two or more objects are definable using various attributes. In a first example, the attributes are based on an affinity between products. For example, a “t-shirt” has a greater amount of affinity towards “jeans” than in relation to “formal trousers.” Similarly, an affinity of “formal trousers” is greater is relation toward “formal shoes” than towards a “casual sneaker.”

In a second example, affinity is based on style related to a product. Examples of style include “retro,” “formal,” “modern,” “party wear,” “casual,” “beach,” and other attributes. Accordingly, an object having a “formal wear” style attribute is treated as having a relatively low affinity with respect to a “beach style” labeled object.

In a third example, affinity of objects toward each other is based on compatibility of different color combinations of the objects with each other. For example, blue jeans are considered compatible with a white t-shirt and thus have a relatively high amount of affinity towards each other. On the other hand, a red t-shirt and yellow-colored jeans are not considered compatible and thus have a relatively low amount of affinity towards each other.

FIG. 8 depicts a system 800 in an example implementation in which the affinity data 716 generated in FIG. 7 is used to train a machine-learning model to generate affinity scores. The affinity data 716, for instance, is received as training data. The affinity data 716 may include positive and negative samples to be used as part of training and retraining of the model.

The machine-learning model 130 is trained to generate an affinity score 802 using the training data. The affinity score 802 quantifies an amount of affinity respective attributes have to each other of respective objects (block 908). The trained machine-learning model 130 is output (block 910), e.g., for use by an affinity scoring module 126 in generating the affinity score 802 as shown in FIG. 8. In this way, the affinity score 802 is configurable to define an amount of affinity (e.g., compatibility) objects have in relation to each other, generally. The affinity score 802 is also usable to define an amount of affinity objects that have respective attributes exhibit towards each other. The affinity score 802 is usable in support of a variety of usage scenarios, an example of which includes a user interface implementing a canvas that supports user inputs to determine affinity of objects towards each other.

### Affinity User Interface

The following discussion describes user interface techniques that are implementable utilizing the previously described systems and devices. Aspects of the procedure are implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to a system 1000 of FIG. 10 in parallel with an example procedure 1100 of FIG. 11 of a user interface configured to output affinity scores via user interaction with a user interface.

FIG. 10 depicts a system 1000 in an example implementation in which an input portion of a user interface operates as a canvas to support user inputs to determine affinity of objects to each other. In this example, the client device 104 includes a browser 1002 having an affinity plug-in module 1004 that is configured to support a communicative coupling with an affinity scoring module 126 of the affinity system 122. The affinity scoring module 126 supports output of a user interface 1006 having an input portion 1008 (e.g., a canvas) that supports user interaction to determine an affinity of selected objects to each other.

A user interface 1006 is displayed that has an input portion 1008 and a plurality of representations 1010 of a plurality of objects (block 1102). In the illustrated example, the browser 1002 is configured to navigate between a plurality of service provider systems and associated digital services, examples of which are illustrated as service provider systems 1012(1), . . . , 1012(N) having associated digital services 1014(1), . . . , 1014(N), e.g., to output webpages.

The display of an input portion 1008 (i.e., the “canvas”) by the affinity plugin module 1004 is configured to persist through navigation between a plurality of different webpages. An input is received that is generated via the input portion as selecting representations of at least two of the plurality of objects (block 1104). The input specifies which objects are to be included within the input portion 1008, e.g., as a drag-and-drop of objects from the webpage into the input portion 1008.

An affinity score is obtained based on the at least two objects. The affinity score specifies a relative amount of affinity of the at least two objects, one to another (block 1106). The affinity score is then displayed in the input portion 1008 of the user interface 1006 along with the representations 1010 of the at least two objects (block 1108).

The affinity plug-in module 1004, for instance, obtains object identifiers corresponding to objects included in the input portion 1008. The object identifiers are then communicated, via the network 106, to the affinity scoring module 126 of the affinity system 122. The affinity scoring module 126 generates an affinity score, e.g., based on affinity rules and/or a machine-learning model which is then communicated based on the client device 104 for display in the user interface 1006. In this way, a user may “drag and drop” objects within the input portion 1008 to determine an amount of affinity those objects have towards each other, e.g., compatible color combinations, sizes, fitment, and so forth. Output of the affinity score is performable in real time, and thus supports efficient user interaction. A variety of other examples are also contemplated.

### Example System and Device

FIG. 12 illustrates an example system generally at 1200 that includes an example computing device 1202 that is representative of one or more computing systems and/or devices that implement the various techniques described herein. This is illustrated through inclusion of the affinity system 122. The computing device 1202 is configurable, for example, as a server of a service provider, a device associated with a client (e.g., a client device), an on-chip system, and/or any other suitable computing device or computing system.

The example computing device 1202 as illustrated includes a processing device 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1204 is representative of functionality to perform one or more operations using hardware. Accordingly, the processing device 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212 that stores instructions that are executable to cause the processing device 1204 to perform operations. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing device 1204. The instructions and/or functions are executable/operable by one or more articles of manufacture (for example, one or more computing devices 1202 and/or processing devices 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In implementations, the platform 1216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying, by a processing device, a user interface having an input portion and a plurality of representations of a plurality of objects;
receiving, by the processing device, an input generated via the input portion as selecting representations of at least two of the plurality of objects;
obtaining, by the processing device, an affinity score based on the at least two objects, the affinity score specifying a relative amount of affinity of the at least two objects, one to another; and
displaying, by the processing device, the affinity score in the portion of the user interface along with the representations of the at least two objects.

2. The method as described in claim 1, wherein the affinity score is based on a relative amount of affinity that attributes, of the respective at least two objects, have to each other.

3. The method as described in claim 1, wherein the receiving the input includes specifying inclusion of the representations of the at least two objects in the input portion and the obtaining is performed automatically and without user intervention responsive to the input.

4. The method as described in claim 1, wherein the user interface is configured to persist display of the input portion during navigation between a plurality of webpages.

5. The method as described in claim 4, wherein the plurality of representations of the plurality of objects is changed responsive to the navigation between the plurality of webpages.

6. The method as described in claim 1, wherein the obtaining is configured to cause generation of the affinity score, automatically and without user intervention, using a machine-learning model.

7. The method as described in claim 6, wherein the machine-learning model is trained by:
selecting a training digital image from a plurality of training digital images;
generating object and attribute data based on the selected training digital image, the object and attribute data describing a correlation of objects as identified within the selected training digital image and respective attributes of the objects included within the selected training digital image; and
training the machine-learning model based on the object and attribute data for the plurality of training digital images.

8. The method as described in claim 7, further comprising identifying the objects within the selected training digital image and the respective attributes of the objects using one or more machine learning models, automatically and without user intervention, and wherein the generating the object and attribute data is based on the identifying.

9. The method as described in claim 1, wherein the generating the affinity score is based on one or more affinity rules, the one or more affinity rules specifying a relative amount of affinity of attributes of the at least two objects have to each other.

10. The method as described in claim 9, wherein the one or more affinity rules are generated by:
outputting a rule generation user interface including a plurality of representations of a plurality of attributes, respectively, of a plurality of objects;
receiving inputs via the rule generation user interface, the inputs specifying an affinity of respective said attributes of the plurality of objects; and
generating the one or more affinity rules based on the affinity of the respective attributes of the plurality of objects as specified by the inputs.

11. The method as described in claim 9, wherein the one or more affinity rules include:
a first said affinity rule specifying a positive affinity between a first said attribute of a first said object and a second said attribute of a second said object; and
a second said affinity rule specifying a negative affinity between a third said attribute of a third said object and a fourth said attribute of a fourth said object.

12. One or more computer-readable storage media storing instructions that, responsive to execution by a processing device, causes the processing device to perform operations including:
outputting a rule generation user interface including a plurality of representations of a plurality of attributes, respectively, of a plurality of objects;
receiving inputs via the rule generation user interface, the inputs specifying an affinity of respective attributes of the plurality of objects, one to another;
generating one or more affinity rules based on the affinity of the respective attributes of the plurality of objects as specified by the inputs; and
generating an affinity score based on a plurality of subsequent objects using the one or more affinity rules.

13. The one or more computer-readable storage media as described in claim 12, wherein the receiving of the inputs is performed responsive to user interaction with a control in the user interface.

14. The one or more computer-readable storage media as described in claim 13, wherein the control is configurable to specify a relative amount of affinity between a first said attribute of a first said object and a second said attribute of a second said object.

15. The one or more computer-readable storage media as described in claim 12, wherein at least one said affinity rule specifies a positive affinity between a first said attribute of a first said object and a second said attribute of a second said object.

16. The one or more computer-readable storage media as described in claim 12, wherein at least one said affinity rule specifies a negative affinity between a first said attribute of a first said object and a second said attribute of a second said object.

17. A computing device comprising:
a processing device; and
a computer-readable storage medium storing instructions that, responsive to execution by the processing device, causes the processing device to perform operations including:
receiving a plurality of training digital images;
identifying a plurality of objects and a plurality of attributes included in respective objects of the plurality of objects in the plurality of training digital images;
generating training data based on the identifying, the training data correlating the plurality of attributes and objects as included in respective said digital images;
training a machine-learning model to generate an affinity score using the training data, the affinity score quantifying an amount of affinity respective said attributes have to each other of respective said objects; and
outputting the trained machine-learning model.

18. The computing device as described in claim 17, wherein the identifying the plurality of objects and the plurality of attributes is performed automatically and without user intervention using a machine-learning model.

19. The computing device as described in claim 17, wherein the generating the training data includes positive training samples based on the plurality of training digital images and negative training samples generated by editing one or more of the plurality of training digital images.

20. The computing device as described in claim 17, wherein the plurality of attributes includes style or color.
